(19) United States
(12) Patent Application Publication
(10) Pub. No.: US 2022/0284410 A1
(43) Pub. Date: Sep. 8, 2022

(54) DISPLAY METHOD, MEDIUM, AND TERMINAL

(71) Applicant: LINE Pay Corporation, Tokyo (JP)

(72) Inventors: Hiroaki ARISADA, Tokyo (JP); Tomohiro OKADA, Tokyo (JP)

(73) Assignee: LINE Pay Corporation, Tokyo (JP)

(21) Appl. No.: 17/749,468

(22) Filed: May 20, 2022

Related U.S. Application Data
(62) Division of application No. 16/377,538, filed on Apr. 8, 2019, now abandoned.
Application No. 16/377,538 is a continuation of application No. PCT/JP2017/005526, filed on Feb. 15, 2017.

(51) Int. Cl. G06Q 20/10; G06Q 20/22; G06Q 50/10

(52) U.S. Cl. CPC G06Q 20/102; G06Q 20/22; G06Q 50/10; G06Q 20/10

(57) ABSTRACT

A display method of displaying a user interface on a display region of a terminal, includes, using at least one processor, generating a user interface, the user interface indicating a total amount of money to be paid by a plurality of users, the user interface including a first display region and a second display region, the first display region corresponding to a first amount of money to be paid by a first user, and the second display region corresponding to a second amount of money to be paid by a second user; displaying, the generated user interface on a display panel of a first terminal associated with the first user; receiving, a user input on the first display region indicating a change in the first amount of money; and changing, the first display region and the first amount of money based on the received user input.

### CROSS-REFERENCE TO RELATED APPLICATIONS

This U.S. non-provisional application is a divisional of U.S. application Ser. No. 16/377,538, filed Apr. 8, 2019, which is a continuation application of, and claims the benefit of priority under 35 U.S.C. § 365(c) from, PCT International Application PCT/JP2017/005526 filed on Feb. 15, 2017, which designated the U.S., the entire contents of each of which are incorporated herein by reference.

### FIELD

The present disclosure relates to a display method, a medium, and a terminal.

### BACKGROUND

Conventionally, opportunities of bill-splitting have been increasing by using information processing terminals. In recent years, bill-splitting using an SNS (Social Network Service) has become available. For example, a technique has been disclosed that facilitates deriving the amount to be paid by each person when multiple persons pay a bill by splitting the bill.

In order to split a bill, it is necessary to calculate what ratio or amount each person pays with respect to the total of the payment. However, the above-mentioned technique that facilitates deriving the amount to be paid by each person when splitting a bill, is not capable of adjusting the ratios or amounts to be paid using an intuitive operation.

The present disclosure has been made in view of the above problem, and has an object to provide a non-transitory computer readable medium, an information processing method, an information processing system, and/or an information processing terminal with which bill-splitting can be made by an intuitive operation.

### SUMMARY

According to an example embodiment in the present disclosure, a display method of displaying a user interface on a display region of a terminal, includes generating, using at least one processor, a user interface, the user interface indicating a total amount of money to be paid by a plurality of users, the plurality of users including at least a first user and a second user, the user interface including a first display region and a second display region, the first display region corresponding to a first amount of money to be paid by the first user, and the second display region corresponding to a second amount of money to be paid by the second user; displaying, using the at least one processor, the generated user interface on a display panel of a first terminal associated with the first user; receiving, using the at least one processor, a user input on the first display region indicating a change in the first amount of money; and changing, using the at least one processor, the first display region and the first amount of money based on the received user input.

### BRIEF DESCRIPTION OF DRAWINGS

FIG. 1 is a diagram illustrating a configuration of a communication system according to an example embodiment;

FIG. 2 is a diagram illustrating a configuration of a communication system according to an example embodiment;

FIG. 3 is a diagram illustrating an example of a sequence of a process in a communication system according to a first example embodiment;

FIG. 4 is a flowchart illustrating an example of a process of generating split bill information;

FIG. 5A is a diagram illustrating an example of an operation of selecting users as parties to be involved in bill-splitting on a split bill information generation screen;

FIG. 5B is a diagram illustrating an example of an operation of selecting users as parties to be involved in bill-splitting on a split bill information generation screen;

FIG. 5C is a diagram illustrating an example of an operation of selecting users as parties to be involved in bill-splitting on a split bill information generation screen;

FIG. 5D is a diagram illustrating an example of an operation of selecting users as parties to be involved in bill-splitting on a split bill information generation screen;

FIG. 5E is a diagram illustrating an example of an operation of selecting users as parties to be involved in bill-splitting on a split bill information generation screen;

FIG. 6A is a diagram illustrating an example of an operation for setting an amount to be paid in bill-splitting on a split bill information generation screen;

FIG. 6B is a diagram illustrating an example of an operation of setting an amount to be paid in bill-splitting on a split bill information generation screen; and

FIG. 6C is a diagram illustrating an example of an operation of setting an amount to be paid in bill-splitting on a split bill information generation screen.

### DETAILED DESCRIPTION

<Observance of Confidentiality of Communication>

Note that when implementing the disclosure in this specification, it should be implemented with observance of legal matters relating to the confidentiality of communication of the involved parties.

Example embodiments will be described with reference to the drawings.

According to the present disclosure, it is possible to provide a non-transitory computer readable medium, an information processing method, an information processing system, and/or an information processing terminal with which bill-splitting can be made by an intuitive operation.

<System Configuration>

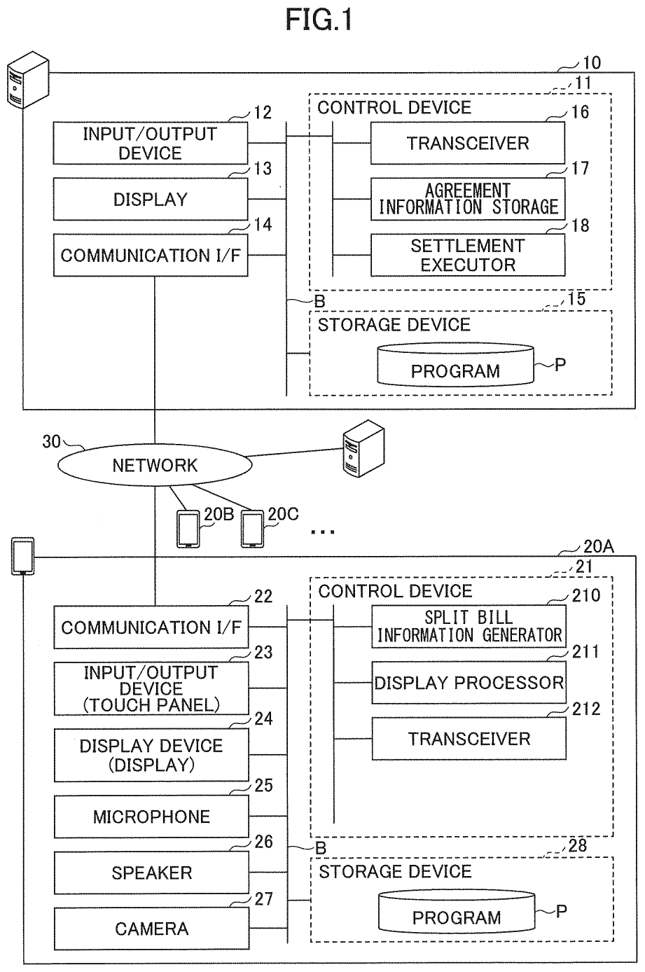

FIG. 1 is a diagram illustrating a configuration of a communication system 1 according to an example embodiment. As illustrated in FIG. 1, the communication system has servers 10 and terminals 20 (terminal 20A, terminal 20B, terminal 20C) connected via a network 30. The server 10 provides a service for realizing transmission and reception of messages among the terminals 20 including one of the terminals 20 owned by a certain user via the network 30. Note that the number of terminals 20 connected to the network 30 is not limited.

The network 30 plays a role of connecting one or more terminals 20 with one or more servers 10. In other words, the network 30 means a communication network that provides a connection path through which a terminal 20 can transmit and receive data after connecting to a server 10.

For example, one or more parts of the network 30 may be a wired network and/or a wireless network. The network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a mobile phone network, integrated service digital networks (ISDNs), wireless LANs, long term evolution (LTE), code division multiple access (CDMA), Bluetooth (registered trademark), satellite communication, etc., and/or a combination of two or more of these. However, in the present disclosure, the network 30 is not limited to these. Also, the network 30 may also include one or more networks.

The terminal 20 (terminal 20A, terminal 20B, or terminal 20C) may be any terminal as long as it can implement functions described in the example embodiments. The terminal 20 is typically a smart phone and may also be a mobile phone (e.g., a feature phone), a computer (e.g., a desktop-type, a laptop-type, a tablet-type, etc.), a media computer platform (e.g., a cable/satellite TV set-top box, a digital video recorder, etc.), a handheld computing device (e.g., a PDA (personal digital assistant), an e-mail client, etc.), a wearable terminal (a glasses-type device, a watch-type device, etc.), or any other type of a computer or a communication platform. However, in the present disclosure, the terminal 20 is not limited to these. Also, the terminal 20 may be expressed as an information processing terminal.

Since configurations of the terminal 20A, the terminal 20B, and the terminal 20C are basically the same, in the following description, the terminal 20 will be described as a representative terminal. Also, when necessary, user information associated with a terminal 20X will be described as user information X, and a user who operates the terminal 20X will be described as the user X. Note that the user information is a part or all of information associated with an account in an SNS (Social Network Service) represented by an instant messenger, for example, a user name or a user image. The user information may also be information such as a user identifier, age, sex, address of the user, or a combination of these. However, the user information is not limited to these.

The server 10 has a function of providing a predetermined service (e.g., a desired service) to the terminal 20. The server 10 may be any type of information processing apparatus as long as it can implement functions described in the example embodiments. The server 10 is typically a server device and may also be a computer (e.g., a desktop-type, a laptop-type, a tablet-type, etc.), a media computer platform (e.g., a cable/satellite TV set-top box, a digital video recorder, etc.), a handheld computing device (e.g., a PDA (personal digital assistant), an e-mail client, etc.), or any other type of a computer or a communication platform. However, in the present disclosure, the server 10 is not limited to these. Also, the server 10 may be referred to as an information processing apparatus.

<Hardware (HW) Configuration>

By using FIG. 1, a HW configuration of each device included in the communication system will be described.

(1) HW Configuration of Terminal

The terminal 20 includes a control device 21 (CPU: central processing unit), a storage device 28, a communication I/F 22 (interface), an input/output device 23, a display device 24, a microphone 25, a speaker 26, and/or a camera 27, etc. The elements of the HW of the terminal 20 are connected to each other, for example, via a bus B.

The communication I/F 22 transmits and receives various items of data via the network 30. The communication may be executed by wire and/or by radio, and any communication protocol may be used as long as mutual communication can be executed. The communication I/F 22 has a function of executing communication with the server 10 via the network 30. The communication I/F 22 transmits various items of data to the server 10 according to a command from the control device 21. Also, the communication I/F 22 receives various items of data transmitted from the server 10, and transmits the data to the control device 21.

The input/output device 23 includes a device for inputting various operations to the terminal 20 and a device for outputting processing results processed by the terminal 20. The input/output device 23 may have the input device and the output device integrated, or have the input device and the output device separated.

The input device is implemented by any one of, or a combination of, all types of devices that can receive input from the user and can transmit information related to the input to the control device 21. The input device is typically implemented by a touch panel or the like, to detect a contact by a pointer, such as a finger of the user or a stylus, and the contact position, and to transmit the coordinates of the contact position to the control device 21. Meanwhile, the input device may be implemented by an input device other than the touch panel. The input device includes, for example, hardware keys represented by a keyboard or the like, a pointing device such as a mouse, a camera (operation input via moving images), and/or a microphone (operation input by voice). However, in the present disclosure, the input device is not limited to these.

The output device is implemented by any one of or a combination of all types of devices capable of outputting results processed by the control device 21. The output device is typically implemented by a touch panel or the like. Meanwhile, the output device may be implemented by an output device other than a touch panel. For example, a speaker (audio output), a lens (e.g., 3D (three dimensional) output, hologram output), a printer, and the like may be included. However, in the present disclosure, the output device is not limited to these.

The display device 24 is implemented by any one of, or a combination of, all types of devices these that can execute displaying according to display data written in a frame buffer. The display device 24 is typically implemented by a monitor (e.g., a liquid crystal display or an OELD (organic electroluminescence display)). The display device 24 may be a head-mounted display (HMD). Also, the display device 24 may be implemented by projection mapping, hologram, or a device that is capable of displaying images, text information, and the like in the air or the like (which may be a vacuum). Note that these display devices 24 may be capable of displaying display data in 3D. However, in the present disclosure, the display device 24 is not limited to these.

In the case where the input/output device 23 is a touch panel, the input/output device 23 and the display device 24 may have substantially the same size and shape to be arranged to face each other.

The control device 21 has a circuit that is physically structured to execute functions implemented by codes or instructions included in a program, and is implemented by, for example, a data processing device built in the hardware.

The control device 21 is typically a central processing unit (CPU), and also may be a microprocessor, a processor core, multiprocessors, an ASIC (application-specific integrated circuit), and/or an FPGA (field programmable gate array), etc. However, in the present disclosure, the control device 21 is not limited to these.

The storage device 28 has a function of storing various programs and various items of data required when the terminal 20 operates. The storage device 28 is implemented by various storage media such as an HDD (hard disk drive), an SSD (solid state drive), a flash memory, a RAM (random access memory), a ROM (read-only memory), and the like. However, in the present disclosure, the storage device 28 is not limited to these.

In the terminal 20, a program P is stored in the storage device 28, and the control device 21 running this program P executes processes corresponding to respective functional units included in the control device 21. In other words, the program P stored in the storage device 28 realizes and/or causes the functions to be executed by the control device 21 on the terminal 20.

The microphone 25 is used for inputting audio data. The speaker 26 is used for outputting audio data. The camera 27 is used for obtaining moving image data.

(2) HW Configuration of Server

The server 10 includes a control device 11 (CPU), a storage device 15, a communication I/F 14 (interface), an input/output device 12, and/or a display 13, etc. The elements of the HW of the server 10 are mutually connected, for example, via a bus B.

The control device 11 has a circuit that is physically structured to execute functions implemented by codes or instructions (e.g., computer readable instructions) included in a program, and is implemented by, for example, a data processing device built in the hardware.

The control device 11 is typically a central processing unit (CPU), and may be a microprocessor, a processor core, multiprocessors, an ASIC, and/or an FPGA, etc. However, in the present disclosure, the control device 11 is not limited thereto.

The storage device 15 has a function of storing various programs and various items of data required for the server 10 to operate. The storage device 15 is implemented by various storage media such as an HDD, an SSD, a flash memory, and the like. However, in the present disclosure, the storage device 15 is not limited to these.

The communication I/F 14 exchanges various items of data via the network 30. The communication may be executed by wire or by radio, and any communication protocol may be used as long as mutual communication can be executed. The communication I/F 14 has a function of executing communication with the terminal 20 via the network 30. The communication I/F 14 transmits various items of data to the terminal 20 according to a command from the control device 11. Also, the communication I/F 14 receives various items of data transmitted from the terminal 20, and transmits the data to the control device 11.

The input/output device 12 is implemented by a device that inputs various operations on the server 10. The input/output device 12 is implemented by any one of, or a combination of, all types of devices that can receive input from the user and can transmit information related to the input to the control device 11. The input/output device 12 is typically implemented by hardware keys represented by a keyboard or the like, a pointing device such as a mouse, and the like. Note that the input/output device 12 may include, for example, a touch panel, a camera (operation input via moving images), and a microphone (operation input by voice). However, in the present disclosure, the input/output device 12 is not limited to these.

The display 13 is typically implemented by a monitor (e.g., a liquid crystal display or an OELD (organic electroluminescence display)). Note that the display 13 may be a head-mounted display (HMD) or the like. Note that these displays 13 may be capable of displaying display data in 3D. However, in the present disclosure, the display 13 is not limited to these.

The server 10 stores the program P in the storage device 15, and the control device 11 running this program P executes processes corresponding to respective functional units included in the control device 11. In other words, the program P stored in the storage device 15 realizes and/or causes the functions to be executed by the control device 11 on the server 10.

Each example embodiment in the present disclosure will be described assuming that it is implemented by the CPU(s) of the terminal 20 and/or the server 10 executing the program P.

The control device 21 of the terminal 20 and/or the control device 11 of the server 10 may be implemented not only by a CPU but also by a logic circuit (hardware) or a dedicated circuit formed in an integrated circuit (IC) chip, an LSI (Large Scale Integration) chip, or the like. Also, these circuits may be implemented by one or more integrated circuits, and multiple processes described in the example embodiments may be implemented by a single integrated circuit. Also, an LSI may also be referred to as a VLSI, a super LSI, an ultra LSI, or the like depending on the degree of integration.

Also, the program P (software program/computer program, computer readable instructions, etc.) of the example embodiments in the present disclosure may be provided in a state stored in a computer-readable recording medium. The recording medium can store the program in a “non-transitory computer-readable tangible medium”.

When appropriate, the recording medium may include one or more semiconductor-based or other integrated circuits (ICs) such as field programmable gate arrays (FPGAs) or application specific integrated circuits (ASICs); a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid state drive (SSD), a RAM drive, a secure digital card or drive, any other suitable recording medium, or any suitable combination of two or more of these. When appropriate, the recording medium may be volatile, non-volatile, or may have a combination of volatility and non-volatility. Note that the recording medium is not limited to these examples, and may be any device or medium as long as it can store the program P.

The server 10 and/or the terminal 20, for example, can read the program P (e.g., computer readable instructions that comprise the program P) stored in the recording medium and execute the read program P to realize the functions of multiple functional units described in each example embodiment.

Also, the program P in the present disclosure may be provided to the server 10 or the terminal 20 via any transmission medium (a communication network, a broadcasting wave, or the like) capable of transmitting the program. The server 10 and/or the terminal 20 realize functions of multiple functional units described in the respective example embodiments by executing the program P downloaded via, for example, the Internet or the like.

Each example embodiment of the present disclosure can also be implemented in a form of a data signal embedded in a carrier wave in which the program P is embodied by electronic transmission. At least a part of the processing in the server 10 and/or the terminal 20 may be realized by cloud computing constituted by one or more computers.

At least a part of the processing in the terminal 20 may be performed by the server 10. In this case, for example, at least part of the processing of each functional unit of the control device 21 of the terminal 20 may be performed by the server 10. In this case, a system having at least one of the server 10 and the terminal 20 may also be referred to as “information processing terminal”.

At least a part of the processing in the server 10 may be performed by the terminal 20. In this case, for example, at least part of the processing of each functional unit of the control device 11 of the server 10 may be performed by the terminal 20.

In the present disclosure, a determination may not be a prerequisite, and it is obvious that a predetermined process may be executed when a determination condition is satisfied or a predetermined process may be executed when a determination condition is not satisfied. In the present disclosure, a configuration of determination is not indispensable, and it goes without saying that predetermined processing may be performed when the determination condition is satisfied or predetermined processing may be performed when the determination condition is not satisfied.

Note that the program in the present disclosure can be implemented by using a script language such as ActionScript, JavaScript (registered trademark), and the like; an object-oriented programming language such as Objective-C, Java (registered trademark), and the like; and a markup language such as HTML5 and the like. However, the present disclosure is not limited to these.

### First Example Embodiment

A first example embodiment has a form in which a terminal generates split bill information based on operational information on the terminal, and transmits the split bill information to the other terminals via a server.

The contents disclosed in the first example embodiment can be applied to any of the other example embodiments.

<Functional Configuration>

(1) Functional Configuration of Terminal

As illustrated in FIG. 1, the terminal 20 includes, as functions implemented by the control device 21, a split bill information generator 210, a display processor 211, and/or a transceiver 212, etc.

The split bill information generator 210 has a function of calculating a ratio to be paid or an amount to be paid by each user in response to an operation performed by the user.

The transceiver 212 transmits the split bill information generated by the split bill information generator 210 to the server 10 or another terminal 20.

The display processor 211 displays display data based on the split bill information generated by the split bill information generator 210 via the display device 24. The display processor 211 has a function of converting display data into pixel information and writing the converted data into a frame buffer of the display device 24.

(2) Functional Configuration of Server

As illustrated in FIG. 1, the server 10 includes, as functions implemented by the control device 11, a transceiver 16, an agreement information storage 17, and/or a settlement executor 18, etc.

The transceiver 16 has a function of transmitting received split bill information to another terminal.

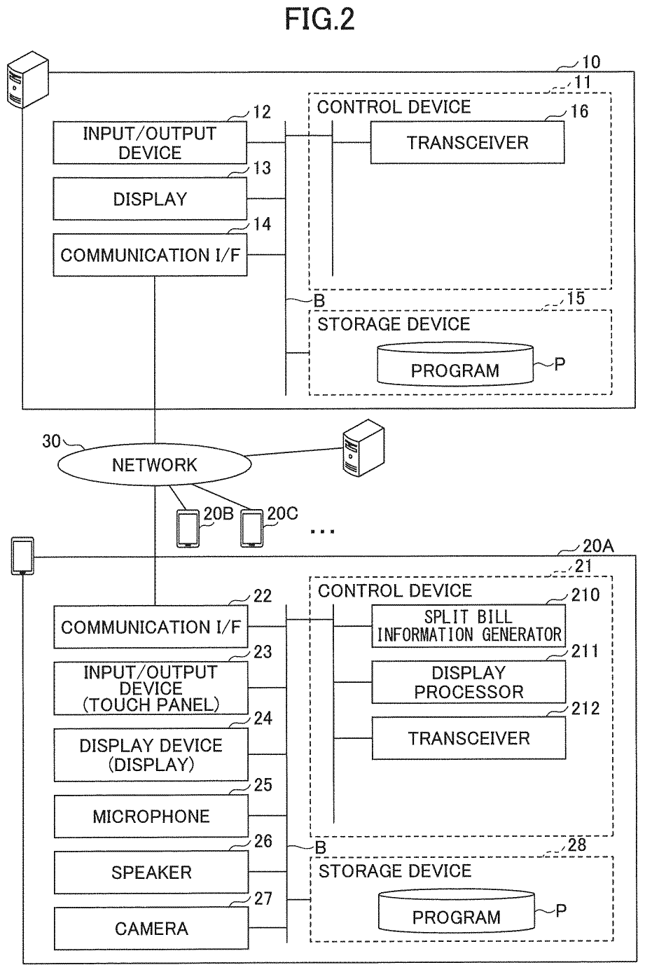

The agreement information storage 17 has a function of storing agreement information with respect to split bill information received from a terminal. The settlement executor 18 has a function of executing settlement based on agreement information from users involved in bill-splitting. However, naturally, such a function may be executed on another server. Further, as illustrated in FIG. 2, the transceiver 16, the agreement information storage 17, and the settlement executor 18 need not be included in the same server 10, and the respective processes may be executed on different servers. In the example in FIG. 2, the agreement information storage 17 and the settlement executor 18 are provided in another server 10 (not illustrated).

<Process>

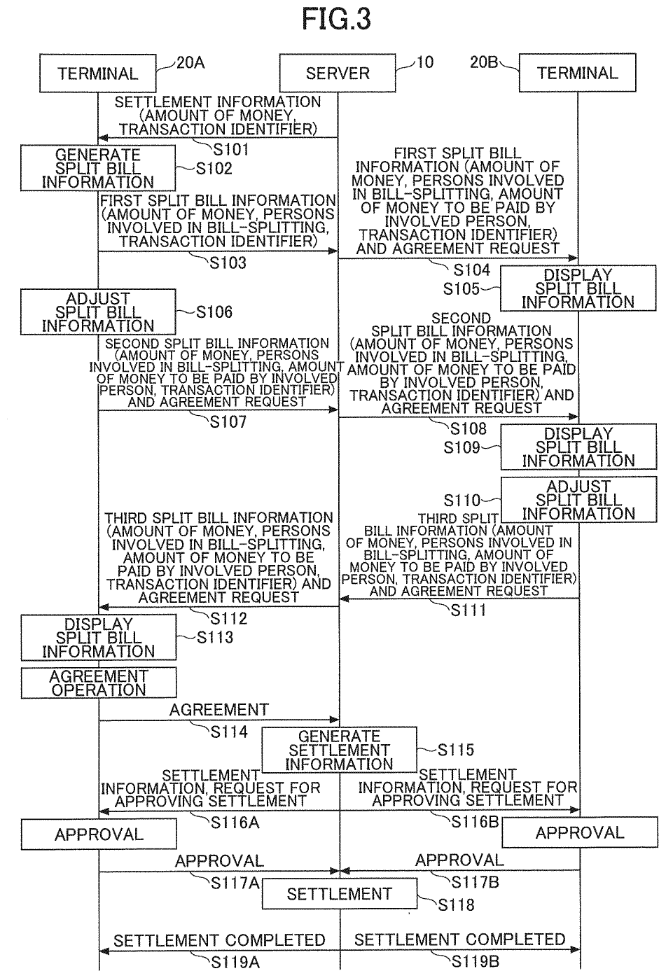

Next, with reference to FIG. 3, a process in the communication system 1 will be described according to the first example embodiment. FIG. 3 is a diagram illustrating an example of a sequence of a process in the communication system 1 according to the first example embodiment.

FIG. 3 illustrates an operation sequence in bill-splitting including multiple users of A and B, when adjusting the ratio or amount to be paid by each of the users A and B.

At Step S101, the transceiver 212 of the terminal 20A obtains settlement information including an amount of money and a transaction identifier from the server 10. The transaction identifier is an ID of a transaction that requires a payment. Here, the split bill information generator 210 of the terminal 20A may cause the display processor 211 to display on the screen at least a part of the obtained settlement information (such as the amount of money to be paid by each user).

Next, the split bill information generator 210 of the terminal 20A generates first split bill information upon an operation performed by the user A (Step S102). Note that the split bill information includes at least one of the amount to be paid, a user involved in the bill-splitting, and the transaction identifier.

Next, the transceiver 212 of the terminal 20A transmits the generated first split bill information to the server 10 (Step S103).

Next, the transceiver 16 of the server 10 transmits the first split bill information and an agreement request to the terminal 20B of the user B as a user involved in the bill-splitting included in the first split bill information (Step S104).

Next, the display processor 211 of the terminal 20B displays at least a part of the received first split bill information on the screen (Step S105).

Next, when the first split bill information has been adjusted by an operation performed by the user A, the split bill information generator 210 of the terminal 20A generates second split bill information (Step S106), and the transceiver 212 of the terminal 20A transmits the generated second split bill information to the server 10 (Step S107). At this time, after the second split bill information has been received, the first split bill information may be deleted or invalidated. This operation prevents either or both of the first split bill information and the second split bill information from becoming valid. The server may set the priority for each of the split bill information based on time information (time stamp) corresponding to the split bill information.

Next, the transceiver 16 of the server 10 transmits the second split bill information and an agreement request to the terminal 20B of the user B as a user involved in the bill-splitting included in the second split bill information (Step S108).

Next, the display processor 211 of the terminal 20B displays at least a part of the received second split bill information on the screen (Step S109).

Next, in the case where the user B will not agree with the amount to be paid or the ratio to be paid shown in the second split bill information, and consequently performs an operation to adjust the second split bill information, in response to receiving the operation, the split bill information generator 210 of the terminal 20B generates third split bill information (Step S110).

Next, the transceiver 212 of the terminal 20B transmits the generated third split bill information to the server 10 (Step S111).

Next, the transceiver 16 of the server 10 transmits the third split bill information and an agreement request to the terminal 20A of the user A as a user involved in the bill-splitting included in the third split bill information (Step S112).

Next, the display processor 211 of the terminal 20A displays at least a part of the received third split bill information on the screen (Step S113).

Next, if the user A agrees with the amount of money to be paid or the ratio to be paid shown in the third split bill information, in response to an agreement operation performed by the user A, the transceiver 212 of the terminal 20A transmits the agreement on the third split bill information to the server 10 (Step S114).

Next, in response to receiving the agreement on the third split bill information from the user A as a user involved in the bill-splitting, the settlement executor 18 of the server 10 generates settlement information for each user based on the third split bill information (Step S115). The settlement information is information required for settlement, and may include information such as a user ID, an account number, a credit card number, and the like.

Next, the transceiver 16 of the server 10 transmits the settlement information and a request for approving the settlement to the terminal 20A and the terminal 20B (Step S116A, Step S116A).

Next, once the transceiver 212 of the terminal 20A and the transceiver 212 of the terminal 20B has received approval operations (confirmation operations) from the user A and the user B, respectively, each of the transceivers 212 transmits the approval of settlement to the server 10 (Step S117A, Step S117B).

Next, in response to receiving the approval of the settlement from the terminal 20A and the terminal 20B, the settlement executor 18 of the server 10 executes the settlement (Step S118). The settlement may be executed by using an external settlement server.

Next, once the settlement has been completed, the transceiver 16 of the server 10 transmits completion of the settlement to the terminal 20A and the terminal 20B (Step S119A, Step S119B).

<<Process of Generating Split Bill Information>>

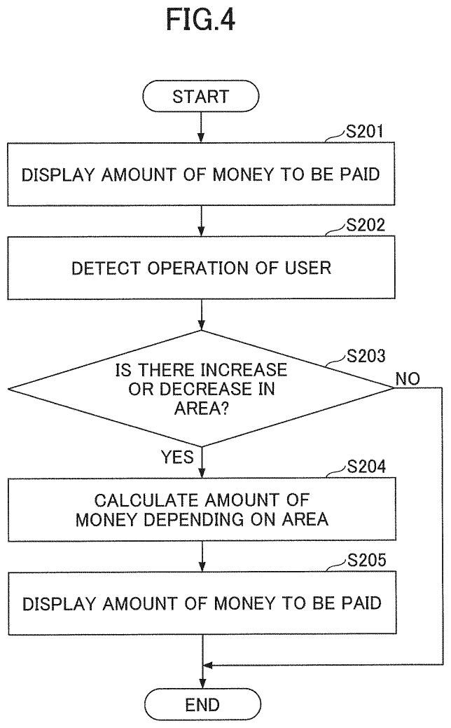

Next, with reference to FIG. 4, a process of generating split bill information executed by the split bill information generator 210 of each of the terminals 20 at Steps S102, S106, and S110 will be described. FIG. 4 is a flowchart illustrating an example of a process of generating split bill information.

At Step S201, the split bill information generator 210 causes the display processor 211 to display the amount of money to be paid by each user and the like on the screen.

Next, the split bill information generator 210 detects an operation performed by the user on the split bill information generation screen for generating split bill information (Step S202).

Next, the split bill information generator 210 determines whether an area has been made larger or smaller by the operation (Step S203).

If an area has not been made larger or smaller by the operation (NO at Step S203), the process is terminated.

If an area has been made larger or smaller by the operation (YES at Step S203), the split bill information generator 210 calculates the amount of money to be paid by each user in accordance with the area and generates split bill information (Step S204).

Next, the split bill information generator 210 causes the display processor 211 to display the calculated amount of money to be paid by each user on the screen (Step S205), and terminates the process.

<<Selection of Users as Parties to be Involved in Bill-Splitting>>

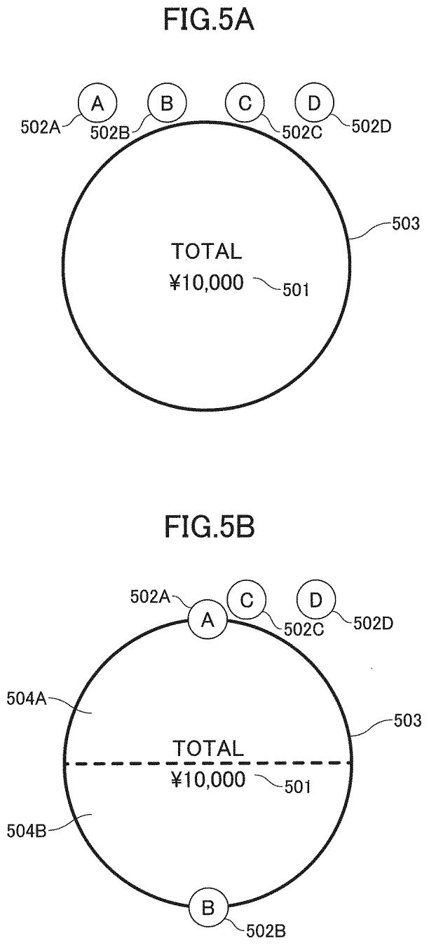

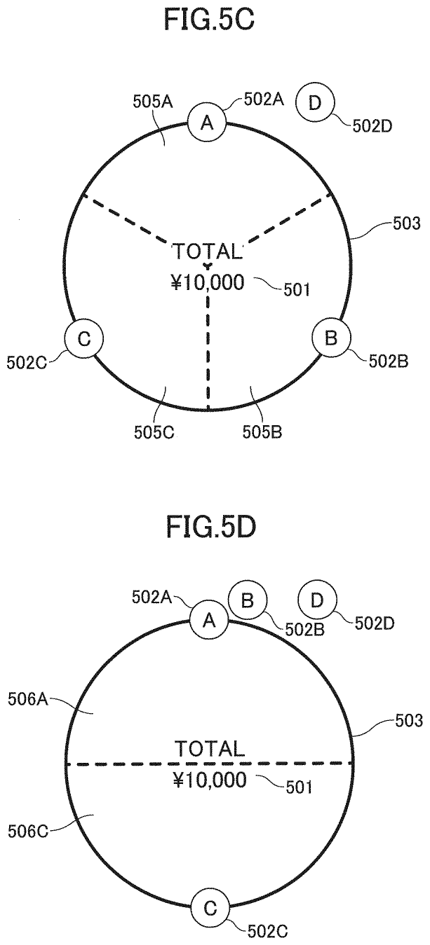

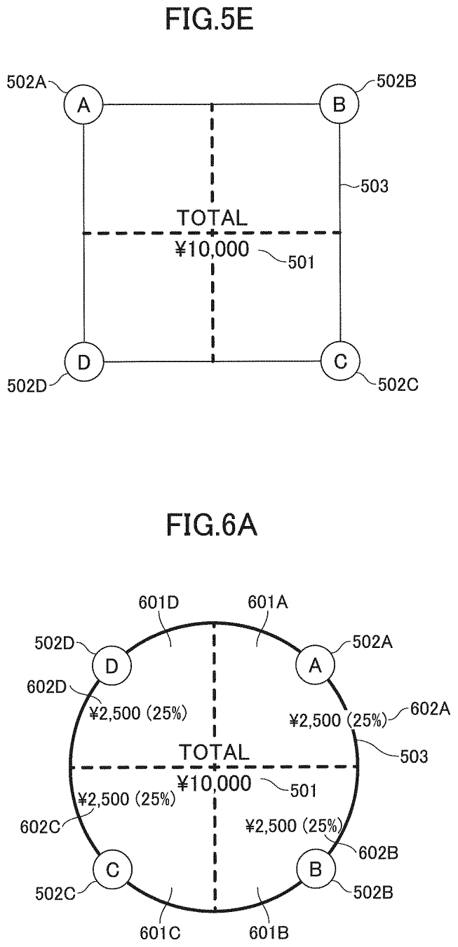

Next, with reference to FIGS. 5A to 5E, examples of operations of selecting users as parties to be involved in bill-splitting on the split bill information generation screen at Step S202 will be described. FIGS. 5A to 5E are diagrams for illustrating examples of operations of selecting users as parties to be involved in bill-splitting on the split bill information generation screen. First, as illustrated in FIG. 5A, on the screen of the terminal 20, a total 501 of payment to be split, user icons 502A to 502D representing user information of users A to user D as candidate parties to be involved in the bill-splitting, and a display region (basic display region) 503 (e.g., a display region user interface) such as a circle are displayed together. The user information of the users A to D may be selected by the user A or may be automatically selected by using short-range communication or the like.

Here, if the user selects the user A and the user B as parties to be involved in the bill-splitting, the split bill information generator 210 changes the display positions of the user icon 502A and the user icon 502B as illustrated in FIG. 5B. Here, any operation may be performed to select the user A and the user B as parties to be involved in the bill-splitting; for example, a swipe operation to move the user icon 502A and the user icon 502B into the display region 503; a tap operation or multiple tap operations performed on the user icon 502A and the user icon 502B; or the like.

Also, the user icon 502A and the user icon 502B are not limited to only icons, and may be information such as user names, user identifiers, images, or the like, or a combination of these.

In the example in FIG. 5B, a display region 504A associated with the user A and a display region 504B associated with the user B are displayed in the display region 503. Note that the ratio of the area of the display region 504A to the area of the display region 504B is equivalent to the ratio of the amount to be paid by the user A to the amount to be paid by the user B. Also, the display region 504A and the display region 504B are displayed so as to have the same area. However, in the case where dividing the total by the number of users involved in the bill-splitting leaves a fraction, the display regions are displayed so as to have visually the same area. Also, for example, in the display region 504A and the display region 504B, the split bill information generator 210 may display the ratio to be paid or the amount of money to be paid by each user.

In the display screen in FIG. 5B, if the user newly selects the user C as a party to be involved in the bill-splitting, the split bill information generator 210 displays a display screen as illustrated in FIG. 5C. In the example in FIG. 5C, display regions 505A to 505C associated with the users A to C, respectively, are displayed in the display region 503. Also, for example, in the display region 505A to the display region 505C, the split bill information generator 210 may display the ratio to be paid or the amount of money to be paid by each user. Note that the ratios of the display region 505A to the display region 505C are equivalent to the ratios to be paid by the users A to C. Also, the display regions 505A to 505C are displayed so as to have the same area. However, in the case where dividing the total by the number of users involved in the bill-splitting leaves a fraction, the display regions are displayed so as to have visually the same area.

In the display screen in FIG. 5C, if the user excludes the user B from the parties involved in the bill-splitting, the split bill information generator 210 displays a display screen as illustrated in FIG. 5D. In the example in FIG. 5D, the display region 505B associated with the user B is excluded from the display region 503 so that in the display region 503, the display region 506A and the display region 506C are displayed so as to have the same area. In other words, the display screen in FIG. 5D is a screen in which the position of the user icon 502B on the display screen in FIG. 5B is replaced by the position of the user icon 502C.

Note that, naturally, the display region 503 is not limited to a circular shape, and any shape may be adopted. For example, as illustrated in FIG. 5E, the shape may be a polygon having sides in accordance with the number of users involved in bill-splitting.

<<Setting Amounts to be Paid in Bill-Splitting>>

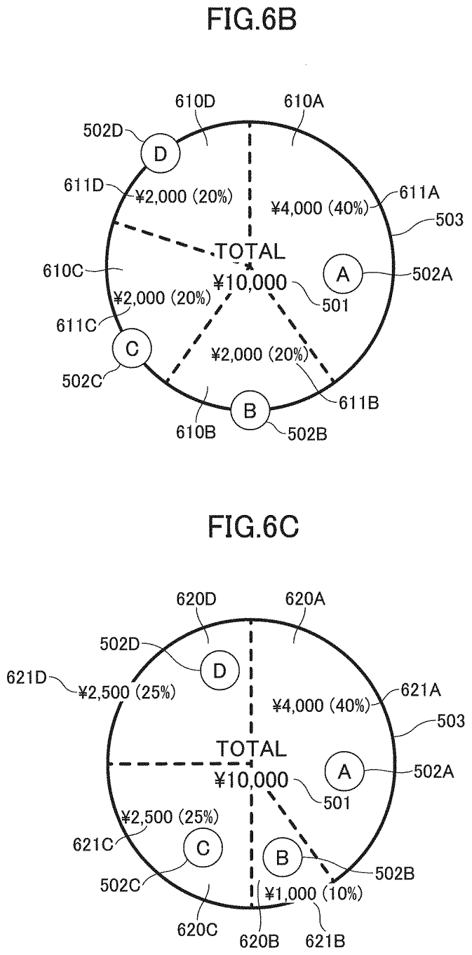

Next, with reference to FIGS. 6A to 6C, examples of operations on the split bill information generation screen at Step S202 will be described. FIGS. 6A to 6C are diagrams for illustrating examples of operations to set amounts to be paid in bill-splitting on the split bill information generation screen. First, as illustrated in FIG. 6A, assume that the users A to D have been selected as parties to be involved in bill-splitting. In this case, display regions 601A to 601D corresponding to the users A to D are displayed to have the same area in the display region 503. In the example in FIG. 6A, in the display regions 601A to the display region 601D, the user icon 502A to the user icon 502D corresponding to the users A to D and the amounts to be paid and the ratios to be paid 602A to 602D are displayed, respectively.

Here, when the user performs an operation to make the area of the display region 601A larger, as illustrated in FIG. 6B, the ratio of the area of the display region 601A to the area of the display region 503 becomes greater (e.g., increases) from 25% to 40% by 15 percentage points. At the same time, the ratio of the area of each of the display region 601B, the display region 601C, and the display region 601D to the area of the display region 503 becomes smaller (e.g., decreases) from 25% to 20% by 5 percentage points. Also, in the example in FIG. 6B, as in FIG. 6A, in the display regions 610A to the display region 610D, the user icon 502A to the user icon 502D corresponding to the users A to D and the amounts to be paid and the ratios to be paid 611A to 611D are displayed, respectively.

Note that in the example in FIG. 6B, although a display form is illustrated in which the areas of the display region 601B to the display region 601D become uniformly smaller, the form is not limited as such; at least one of the display region 601B to the display region 601D may become smaller.

The operation performed by the user to make the area of the display region 601A or the like larger may be any operation such as a swipe operation from the center point of the display region 601A to the outer circumference direction; a pinch-out operation in the display region 601A; a swipe operation in a clockwise direction on one end of a straight line connecting the center point and the circumference of the display region 601A; a predetermined number (e.g., a desired number, etc.) of tap operations on the display region 601A; tap operations for a predetermined time (e.g., a desired time, etc.) on the display region 601A; a tap operation with a predetermined pressure (e.g., a desired pressure, etc.) on the display region 601A; or the like.

On the screen in FIG. 6B, if the user performs an operation to reduce the area of the display region 610B for the user B to be the display region 620B, as illustrated in FIG. 6C, the ratio of the area of the display region 620B for the user B to the area of the display region 503 becomes smaller from 20% to 10% by 10 percentage points, and the areas of the display region 610C and the display region 610D are enlarged from 20% by 5 percentage points, to become 25% as are the area of the display region 620C and the display region 620D. Also, in the example in FIG. 6C, similarly to FIGS. 6A and 6B, in the display region 620A to the display region 620D, the user icon 502A to the user icon 502D corresponding to the users A to D, and the amounts of money to be paid and the ratios to be paid 621A to 621D are displayed, respectively.

Note that FIG. 6C illustrates a display form in which the area of the display region 620A already operated by the user is not changed (adjusted), and the areas of the display region 620C and the display region 620D are uniformly made larger; however, the display form is not limited as such.

The operation performed by the user to make the area of the display region 610B or the like smaller may be any operation such as a swipe operation from the outer circumference of the display region 610B to the center point direction; a pinch-in operation in the display region 610B; a swipe operation in a counter-clockwise direction on one end of a straight line connecting the center point and the circumference of the display region 610B; a predetermined number of tap operations on the display region 610B; tap operations for a predetermined time on the display region 610B; a tap operation with a predetermined pressure on the display region 610B; or the like.

Also, with respect to FIGS. 5A to 5E and FIGS. 6A to 6C, although examples of display forms on the terminal 20A have been illustrated, for example, on the terminal 20B, a screen is displayed in which the information on the user A in FIGS. 5A to 5E and FIGS. 6A to 6C is exchanged with the information on the user B. In other words, on each terminal 20, information on the user of the terminal 20 is displayed at a position that can be relatively easily viewed such as on the upper side or on the upper right side.

<Types of Display Forms>

Naturally, the display forms on the terminal 20 are not limited as such; the display region corresponding to a user of a terminal 20 may be displayed in a display form different from the display region corresponding to another user; or a display region having the largest area may be displayed in a different display form. Here, different display forms include visually different display forms, for example, change of the color and/or transmittance; enlargement or reduction of the display region; displaying in a form that superimposes the underlying display region 503; and the like.

Also, the amount of money to be paid and/or the ratio to be paid by a user of one terminal 20 may be displayed in a form different from the amount of money to be paid and/or the ratio to be paid by another user. Specifically, user information on the users other than the user of one terminal 20 such as the amounts of money to be paid and the ratios to be paid, the user icons, and the like may be displayed in a form so that the user information on the other users cannot be confirmed by the user of one terminal 20.

<<Modified Examples of Setting Amounts to be Paid in Bill-Splitting>>

Next, modified examples of the process of changing the area of a display region after having adjusted the area of the display region for one user as illustrated in FIGS. 6A to 6C will be described.

### First Modified Example Example

A first modified example is a modified example in which, when the area of the display region for one user has been adjusted, the display region already operated by the user is not automatically adjusted, and only the display regions for other users that have not been operated by the user are automatically adjusted. This modified example can be applied to the example embodiments and the other modified examples.

As described with reference to FIGS. 6A and 6B, in response to the first user operation, for example, the ratio of the area of the display region corresponding to the user A becomes greater (e.g., increases) from 25% to 40% by 15 percentage points, and each of the ratios of the areas of the display regions corresponding to the user B to the user D becomes smaller (e.g., decreases) from 25% to 20% by 5 percentage points.

Next, as described with reference to FIG. 6C, in response to the second user operation, for example, the ratio of the area of the display region corresponding to the user B becomes smaller (e.g., decreases) from 20% to 10% by 10 percentage points, and each of the ratios of the areas of the display regions corresponding to the user C to the user D becomes greater (e.g., increases) from 20% to 25% by 5 percentage points. At this time, the ratio of the area of the display region corresponding to the user A that has been already operated does not change.

Next, in response to a third user operation, for example, the ratio of the area of the display region corresponding to the user C becomes greater (e.g., increases) from 25% to 55% by 30 percentage points, and the ratio of the area of the display region corresponding to the user D becomes smaller (e.g., decreases) from 25% to −5% by 30 percentage points. At this time, the ratios of the areas of the display regions corresponding to the user A and the user B that have been already operated do not change.

In this way, the ratio of a display region for a certain user may become a negative number. In this case, a message may be displayed to prompt the user to operate each display region, or the process may be stopped so as not to proceed to the next step. In other words, only when the ratio of the area of each display region takes a positive value, the process may proceed to the next step.

Also, after the display region for every user has been operated once or more, no matter which display region is operated, only the display region is adjusted. Therefore, the total of the display regions may exceed 100% or may not reach 100%. In such a case, excess or shortage may be clearly indicated to prompt an operation by the user. In such a case, the excess or shortage may be evenly distributed among all users, or may be distributed to selected users.

### Second Modified Example

A second modified example is a modified example in which when the area of the display region for one user has been adjusted, the display region that has been most recently operated by the user is not automatically adjusted, and only display regions other than the display region that has been most recently operated by the user are automatically adjusted. This modified example can be applied to the example embodiments and the other modified examples.

As described with reference to FIGS. 6A and 6B, in response to the first user operation, for example, the ratio of the area of the display region corresponding to the user A is increased from 25% to 40% by 15 percentage points, and each of the ratios of the areas of the display regions corresponding to the user B to the user D becomes smaller from 25% to 20% by 5 percentage points.

Next, as described with reference to FIG. 6C, in response to the second user operation, for example, the ratio of the area of the display region corresponding to the user B becomes smaller from 20% to 10% by 10 percentage points, and each of the ratios of the areas of the display regions corresponding to the user C to the user D becomes greater (e.g., increases) from 20% to 25% by 5 percentage points. At this time, the ratio of the area of the display region corresponding to the user A that has been operated immediately before the second user operation does not change.

Next, in response to a third user operation, for example, the ratio of the area of the display region corresponding to the user C becomes greater (e.g., increases) from 25% to 80% by 55 percentage points; the ratio of the area of the display region corresponding to the user A becomes smaller (e.g., decreases) from 40% to 15% by 25 percentage points; and the ratio of the area of the display region corresponding to the user D becomes smaller (e.g., decreases) from 25% to −5% by 30 percentage points. At this time, the ratio of the area of the display region corresponding to the user B that has been operated immediately before the third user operation does not change.

In this way, the ratio of a display region for a certain user may become a negative number. In this case, a message may be displayed to prompt the user to operate each display region, or the process may be stopped so as not to proceed to the next step. In other words, only when the ratio of the area of each display region takes a positive value, the process may proceed to the next step.

### Third Modified Example

A third modified example is a modified example in which when the area of the display region for one user has been adjusted, the areas of the display regions for all users are automatically adjusted. This modified example can be applied to the example embodiments and the other modified examples.

As described with reference to FIGS. 6A and 6B, in response to the first user operation, for example, the ratio of the area of the display region corresponding to the user A is increased from 25% to 40% by 15 percentage points, and each of the ratios of the areas of the display regions corresponding to the user B to the user D becomes smaller (e.g., decreases) from 25% to 20% by 5 percentage points.

Next, as described with reference to FIG. 6C, in response to the second user operation, for example, the ratio of the area of the display region corresponding to the user B becomes smaller (e.g., decreases) from 20% to 10% by 10 percentage points, and each of the ratios of the areas of the display regions corresponding to the user A, the user C, and the user D becomes greater (e.g., increases) by 3.333 percentage points (10/3 percentage points), which results in 43.333% for the ratio of the area of the display region corresponding to the user A, and 23.333% for each of the ratios of the areas of the display regions corresponding to the user C and the user D.

In this way, in the case where a fraction below the decimal point is generated in response to an operation, when the total is multiplied by a ratio, a fraction may be generated. In this case, considering that settlement may not be executed if there is a fraction below a monetary unit, one of the following steps may be executed.

(1) Round up the decimal fraction of the amount to be paid by each user.
(2) Round up the decimal point of the amount of money to be paid by a selected user.
(3) Display a message to prompt the user to operate each display region.
In addition, the process is stopped so as not to proceed to the next step. In other words, only when the ratio of the area of each display region takes a positive value, the process may proceed to the next process.

Note that if the above step (1) is executed, the total to be paid by all users becomes greater than the total payment. In this case, the difference between the total payment and the total to be paid by all users may be paid to a company or the like as the biller of the payment; may be paid to a company as the provider of the bill-splitting service described above; or may be reserved as a deposit that can be used for bill-splitting with the same combination of the users for the next time.

In the present disclosure, a determination may not be a requisite, and it is obvious that a predetermined process (e.g., desired process) may be executed when a determination condition is satisfied or a predetermined process may be executed when the determination condition is not satisfied.

The present disclosure has been described with reference to the drawings and example embodiments. Note that a person skilled in the art can easily make various transformations and modifications based on the present disclosure. Therefore, it should be noted that such transformations and modifications are within the scope in the present disclosure. For example, the functions or the like included in functional units, steps, and the like are relocatable as long as not introducing logical contradiction, and multiple functional units, steps, and the like can be combined into one entity, or can be further divided. Also, the elements described in the respective example embodiments may be appropriately combined.

What is claimed is:

1. An information processing method of a first terminal of a first user and a second terminal of a second user, the first terminal communicating with the second terminal, the method comprising:
displaying, using at least one processor of a first terminal, a first user interface on the first terminal, the first user interface indicating a total amount of money to be paid by a plurality of users, the plurality of users including at least the first user and the second user, the first user interface including a first display region and a second display region, the first display region corresponding to a first amount of money to be paid by the first user, and the second display region corresponding to a second amount of money to be paid by the second user;
receiving, using the at least one processor of the first terminal, a first user input on the first display region indicating a change in the first amount of money;
controlling, using the at least one processor of the first terminal, a change to the first display region and the second display region based on the first user input;
transmitting, using the at least one processor of the first terminal, first information to the second terminal based on the changing the first display region based on the first user input, the first information including a third amount of money to be changed from the first amount of money or a fourth amount of money to be changed from the second amount of money;
receiving, using at least one processor of the second terminal, the first information from the first terminal;
receiving, using the at least one processor of the second terminal, a second user input by the second user in response to the receiving the first information, the second user input indicating approval of the third amount of money or the fourth amount of money by the second user;
transmitting, using the at least one processor of the second terminal, a second information, the second information related to the approval of the third amount of money or the fourth amount of money based on the received second user input;
displaying, using the at least one processor of the first terminal, third information indicating completion of payment based on the third amount of money or the fourth amount of money on the first user interface; and
displaying, using the at least one processor of the second terminal, the third information on a second user interface.

2. The display method as claimed in claim 1, wherein the first user interface includes:
a third display region changed from the first display region, the third display region corresponding to the third amount of money to be paid by the first user; and
a fourth display region changed from the second display region, the fourth display region corresponding to the fourth amount of money to be paid by the second user.

3. The display method as claimed in claim 2, the display method further comprising:
displaying, using the at least one processor of the second terminal, a second user interface on the second terminal in response to receiving the first information, the second user interface including the third display region and the fourth display region.

4. The display method as claimed in claim 1, wherein the first information is sent to the second terminal via a server.

5. The display method as claimed in claim 4, wherein a processing related to the payment is executed by the server.

6. The display method as claimed in claim 1, wherein
the plurality of users includes a third user;
the total amount of money is paid by at least the first user, the second user, and the third user;
the first user interface includes a fifth display region corresponding to a fifth amount of money to be paid by the third user; and
the display method further comprises:
controlling, using the at least one processor of the first terminal, a change to a size of the fifth display region to a sixth display region based on the first user input received on the first display region.

7. The display method as claimed in claim 6, wherein the payment is executed based on information of the third amount of money, information of the fourth amount of money, and information of a sixth amount of money in response to the changing of the size of the first display region by the first user input.

8. The display method as claimed in claim 7, wherein
the first information includes the information of the third amount of money, the information of the fourth amount of money, and the information of the sixth amount of money; and the display method further comprises,
transmitting, using the at least one processor of the first terminal, the first information to a third terminal of the third user.

9. The display method as claimed in claim 1, wherein the first user interface includes a fifth display region corresponding to a fifth amount of money to be paid by a third user, in response to the third user being added.

10. The display method as claimed in claim 9, the display method further comprising:
controlling, using the at least one processor of the first terminal, a change to make a size of the first display region larger, in response to the third user being removed from the plurality of users.

11. The display method as claimed in claim 1, the display method further comprising:
selecting, using the at least one processor of the first terminal, the second user to pay at least a portion of the total amount of money based on a third user input on the first display region; and
controlling, using the at least one processor of the first terminal, adding the second display region on the first user interface based on the selection of the second user.

12. The display method as claimed in claim 1, the display method further comprising:
displaying, using the at least one processor of the first terminal, an image indicating the first user, the image indicating the first user being superimposed on at least a portion of the first display region.

13. A system comprising:
a first terminal associated with a first user;
a second terminal associated with a second user;
the first terminal is configured to,
display a first user interface on the first terminal, the first user interface indicating a total amount of money to be paid by a plurality of users, the plurality of users including at least the first user and the second user, the first user interface including a first display region and a second display region, the first display region corresponding to a first amount of money to be paid by the first user, and the second display region corresponding to a second amount of money to be paid by the second user,
receive a first user input on the first display region indicating a change in the first amount of money,
control a change to the first display region and the second display region based on the first user input, and
transmit first information to the second terminal based on the changing the first display region based on the first user input, the first information including a third amount of money to be changed from the first amount of money or a fourth amount of money to be changed from the second amount of money;
the second terminal is configured to,
receive the first information from the first terminal,
receive a second user input by the second user in response to the receiving the first information, the second user input indicating approval of the third amount of money or the fourth amount of money by the second user,
transmit a second information, the second information related to the approval of the third amount of money or the fourth amount of money based on the received second user input, and
display third information indicating completion of payment based on the third amount of money or the fourth amount of money on a second user interface on the second terminal; and
the first terminal is further configured to,
display the third information on the first user interface.
